(19) United States
(12) Patent Application Publication
(10) Pub. No.: US 2012/0278883 A1
(43) Pub. Date: Nov. 1, 2012

(54) Method and System for Protecting a Computing System

(75) Inventor: Mark G. Gayman, Orem, UT (US)

(73) Assignee: RAYTHEON COMPANY, Waltham, MA (US)

(21) Appl. No.: 13/096,350

(22) Filed: Apr. 28, 2011

(51) Int. Cl. G06F 21/00

(52) U.S. Cl. 726/19

(57) ABSTRACT

The system relates to a method for protecting a computer system application. In one aspect of the method, a wrapper program is installed on a computer system and the computer system application is embedded within the wrapper program. In another aspect, the wrapper program verifies with a user prior to allowing the computer system application to be invoked.

### TECHNICAL FIELD

This disclosure relates to a method and system for protecting a computer system application. More specifically, this disclosure relates to a method and system for protecting a computer system application wherein the method includes embedding the computer system application in a wrapper program and verifying attempts to launch the computer system application by a user prior to actually intentionally launching the computer system application.

### BACKGROUND OF THE INVENTION

Computer systems are regularly subjected to attack. These attacks can come in many forms. Often times, an attacker seeks to gain access to a computer system, or cause damage to a computer system, by executing applications on a computer system without a user's knowledge.

One type of software used for attacks is commonly referred to as malicious software, or malware. This malware is designed to access or control portions of a computer system without the informed consent of the user. In fact, in some situations, malware may attempt to access or control portions of a computer system without the user's knowledge. Malware may include computer viruses, worms, trojan horses, spyware, adware, scareware, crimeware, rootkits, and other malicious software.

According to Symantec, “the release rate of malicious code and other unwanted programs may be exceeding that of legitimate software applications.” Symantec Internet Security Threat Report: Trends for July-December 2007 (Executive Summary).

Malware generally is targeted at software programs installed on a computer system. For instance, cmd.exe is installed on every Microsoft Windows computer system. Malware can be used to hijack cmd.exe for various illicit purposes, including: creating reverse shells by piping input and outputs to a remote site; invoking programs in the background; and deleting programs.

Hence, there exists a need in the industry to overcome these problems and provide a method and system for protecting a computer system application. Additionally, there exists a need to protect a computer system application which is particularly vulnerable to malicious software.

### SUMMARY OF THE INVENTION

According to one embodiment of the present disclosure, a method of protecting a computer system application is disclosed. In one aspect of the method, a wrapper program is installed on the computer system. The computer system application to be protected is then embedded in the wrapper program. The computer system is then configured to prevent users from being able to directly execute the computer system application without utilizing the wrapper program. In another aspect, the wrapper program verifies a user's attempt to execute a protected computer system application prior to allowing the user to invoke the protected computer system application.

One technical advantage of one embodiment of the disclosure may be the ability to protect computer system applications, and particularly computer system applications which are generally susceptible to attack.

Another technical advantage of one embodiment of the disclosure may be the ability to verify with a user prior to allowing a protected computer system application to be run on a computer system.

Another technical advantage of one embodiment of the disclosure may be the ability to verify a user's credentials prior to allowing a protected computer system application to be invoked.

Various embodiments of the disclosure may have none, some, or all of these advantages. Other technical advantages of the present disclosure may also be readily apparent to one skilled in the art.

### BRIEF DESCRIPTION OF THE DRAWINGS

For a more complete understanding of the present disclosure and its advantages, reference is now made to the following descriptions, taken in conjunction with the associated drawings, in which:

FIG. 1 is a flow chart illustrating one embodiment of a series of steps that may be performed in accordance with the teachings of the present disclosure.

FIGS. 2a and 2b are block diagrams illustrating one embodiment of a system in accordance with the teachings of the present disclosure.

FIG. 3 is an illustration of a display being utilized in accordance with the teachings of the present disclosure.

FIG. 4 is another illustration of a display being utilized in accordance with the teachings of the present disclosure.

### DETAILED DESCRIPTION OF THE DRAWINGS

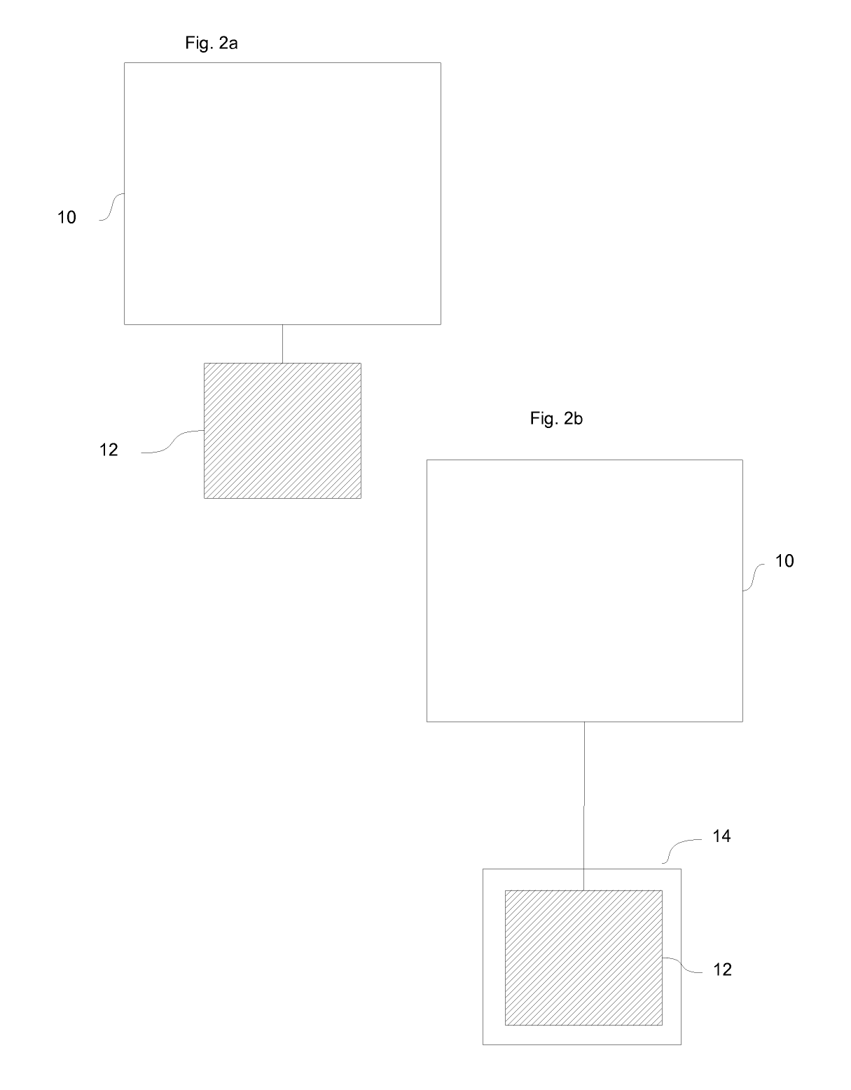

In referring now to FIGS. 2a-2b, illustrations can be seen of one embodiment of a system in accordance with the teachings of the present disclosure. The disclosed system 10 relates to a system and method for protecting a computer system application 12. In one aspect of the disclosure, the computer system application 12 is embedded in a wrapper program 14, wherein the wrapper program 14 verifies a user's attempt to launch the computer system application 12 prior to allowing the launching thereof.

In one embodiment, one such program that may be protected is a command-line interpreter or shell of the computer system. A command-line interpreter or command-line interface is a mechanism for interacting with a computer operating system. This permits commands to be executed by typing them in to a computer system, as opposed to using a graphical user interface. Once a command is entered into a command-line interface, a command-line interpreter parses the command and then performs the requested action.

Examples of command-line interfaces include cmd.exe, command.com, and various UNIX shells such as sh, ksh, bash, csh, and tcsh. The discussion that follows will focus on cmd.exe in a Windows operating system, but the present disclosure may apply equally to any other computer system application to be protected for any operating system (including, for example, Linux, FreeBSD, OS/2 and OS X)

For instance, other computer system applications which may be protected in accordance with the present disclosure may be ipconfig.exe, net.exe, netstat.exe, arp.exe, at.exe, cacls.exe, find.exe, finger.exe, ping.exe, hostname.exe, nbstat.exe, route.exe, rcp.exe, telnet.exe, ifconfig, net, ping, arp, at, finger, hostname, route, rcp, telnet, iwconfig, iproute2, netstat, ipmaddr, ip, nslookup, and traceroute. This list is exemplary and not exhaustive.

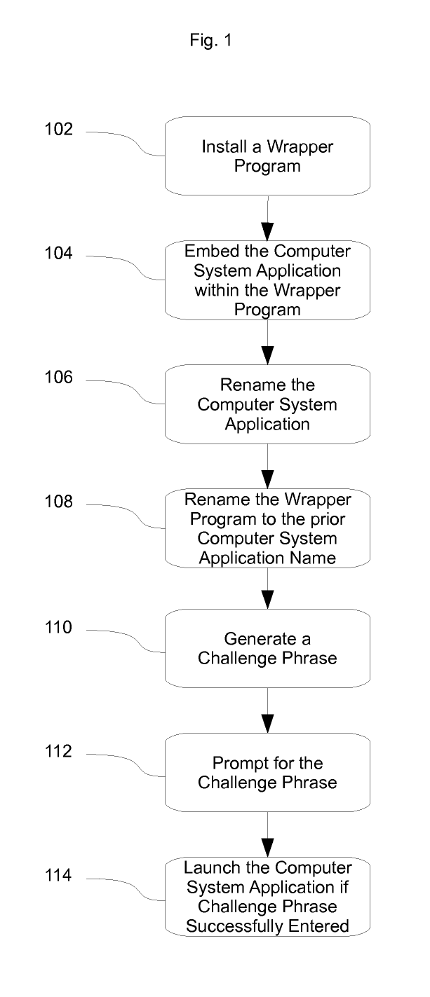

FIG. 1 discloses a series of steps that may be performed in one embodiment in accordance with the teachings of the present disclosure. The method begins at step 102 by installing a wrapper program 14 on the computer system 10. The wrapper program 14, as will be discussed below, will be used as a form of replacement for the computer system application 12. From a user's perspective, any attempts to invoke the computer system application 12 will actually invoke the wrapper program 14. The wrapper program 14, in turn, may then perform steps discussed below prior to invoking the requested computer system application 12.

For example, a user attempting to invoke cmd.exe in a system 10 utilizing the present disclosure would do so in a suitable manner, such as by clicking a cmd.exe button or link. Rather than invoking cmd.exe directly, the system would invoke the wrapper program 14, which in one embodiment may perform the steps discussed below prior to launching cmd.exe.

Returning to FIG. 1, at step 104 the computer system application 12 is embedded within the wrapper program 14. This may be accomplished in a number of different ways and on a number of different file systems. For example, in one embodiment if the computer system 10 utilizes a New Technology File System (NTFS), the computer system application 12 may be copied into an alternate stream of the wrapper program 14. This alternate stream is also known as a data or resource fork in some operating systems.

On the other hand, if the computer system 10 utilizes a file system which includes resources (for instance, a File Allocation Table (FAT), or a File Allocation Table 32 (FAT32)), the computer system application 12 may be embedded as a resource in the wrapper program 14. The present disclosure may be used with any number of file systems, including ext3, ext4, HPFS, FAT12, etc.

In another embodiment, the computer system application 12 may further be modified when embedded in the wrapper program 14 to increase security. In such embodiment, the computer system application 12 may be embedded in the wrapper program 14 in an encrypted format. Thus, attempts to decipher the contents of a wrapper program 14 (for instance, using a hex editor or the like) would not glean any information about the protected computer system application 12 that is within.

A system in accordance with the present disclosure may further utilize environment variables to determine which computer system application 12 to protect. For instance, in the case of cmd.exe on a Windows computer system, a method in accordance with the present disclosure may utilize the COMPSPEC variable to determine the location of the cmd.exe which is to be protected.

Next, at step 106, the computer system application 12 may be renamed to some other name. This other name can be configured to be any other name in an attempt to hide the original computer system application 12 from a user process. More specifically, by hiding the original computer system application 12, malware attempting to invoke the standard computer system application 12 on computer system 10 will be unable to do so. This further adds to the protection of the computer system 10 against such attacks.

In one embodiment of the present disclosure, the computer system application 12 may be renamed to something simple that a user could derive. For instance, renaming cmd.exe to cmd.exe. In another embodiment, the name of the original computer system application 12 is obfuscated. Obfuscation is the process of intentionally adding ambiguity to make discovery more difficult. For instance, cmd.exe may be renamed asfif.exe, or any other seemingly meaningless name. In another embodiment, the name of the original computer system application 12 may be altered before or after each use of the wrapper program 14 to further guard against discovery.

Notably, in changing the name of the computer system application 12, the method does not alter the associated environment variables which may pertain to the computer system application 12. Thus, in the cmd.exe example, while cmd.exe is renamed (and thus not currently present on the subject system except for as discussed below), the COMSPEC variable remains the same. Thus, programmatic attempts to determine the command-line interpreter on such a Windows machine will still identify “cmd.exe.”

Once the computer system application 12 has been renamed, the wrapper program 14 may be renamed to that of the original computer system application 12 at step 108. Thus, in the cmd.exe example, the wrapper program 14 would be renamed to “cmd.exe.” Any further attempts to launch cmd.exe would actually launch the wrapper program 14. By leaving any environment variables untouched, all attempts to execute those computer system applications 12 identified by their respective environment variables will invoke the respective wrapper programs 14 associated therewith.

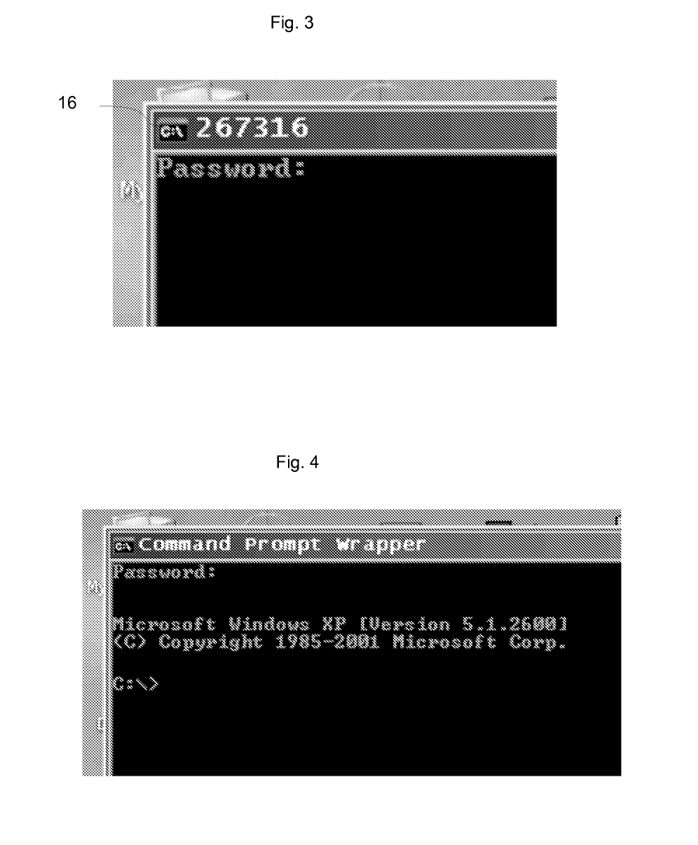

At step 110, steps which may be used by the wrapper program 14 to prevent unauthorized invocation of the protected computer system application 12 are disclosed. In one embodiment, the wrapper program 14 generates a challenge phrase 16 (See FIG. 3). This challenge phrase 16 is some token or other identifier which may preferably be presented to a user, requiring the user's response. This assists in protecting against unwanted and unauthorized access to computer system applications 12 by verifying first that a user is attempting to invoke the subject application, and is willing and able to enter appropriate credentials for enabling such actions.

Thus, at step 112, the challenge phrase 16 may be presented to the user. In one embodiment, the challenge phrase may be a random string of characters. For instance, the challenge phrase may be a random string of six decimal digits. It may be preferable to utilize a random string to further guard against programatic attempts to circumvent this protection.

Prompting the user for the challenge phrase 16 may also require the user to enter the user's system credentials. For instance, the user may be required to enter a password as part of the challenge phrase.

In one embodiment, the user may be prompted to enter the challenge phrase 16 by presenting the challenge phrase 16 in the title bar of a window. For example, FIG. 3 illustrates an embodiment where the challenge phrase 16 is a six digit decimal string which is placed in the title bar of a window. In one embodiment, it is preferable that the user be required to enter a password combined with the challenge phrase 16. For instance, the user may be required to type in a password concatenated with the challenge phrase. Using the example of FIG. 3, the user may be required to enter <password>267316. A system in accordance with the present disclosure may then split the user's input into its respective components (the user's password and the user's response to the challenge phrase 16). A system may then query the operating system's authentication capabilities (or any other authentication mechanism) to determine if the user's password is correct. The system may then also compare the user's response to the challenge phrase 16 to determine that it matches the challenge phrase 16 the wrapper program 14 presented to the user.

If the user is unable to enter the appropriate information, the wrapper program 14 does not launch the computer system application 12. Thus, malware that does not know, and is unable to determine, the proper responses to the challenge phrase 16 will be unable to launch the protected computer system application 12. The wrapper program 14 may present the user a set number of attempts to enter the appropriate response. The wrapper program 14 may be further configured to limit the number of attempts permitted to guard against brute force attempts to circumvent the wrapper program's 14 verification.

Once a user enters the appropriate response to the challenge phrase 16, the wrapper program 14 will launch the protected computer system application 12 at step 114. FIG. 4 is an illustration of what an interface may look like after the wrapper program 14 (“Command Prompt Wrapper”) has successfully verified the user's ability to launch the computer system application 12.

The wrapper program 14 may also be configured to log attempts to invoke the computer system application 12. This log may include any relevant information, including whether or not the computer system application 12 was successfully invoked, how often a user attempted to invoke the computer system application 12, and which user made the attempt. Any other relevant information could be included in the log to assist with protecting the computer system 10 from malware.

The wrapper program 14 may also change the title bar and launch the computer system application 12, or may leave the title bar in an altered state. The wrapper program 14 may use a number of mechanisms to execute or launch the protected computer system application 12. Where the computer system application 12 is embedded as a resource of the wrapper program 14, the wrapper program 14 may extract the computer system application 12 into a temporary location on the computer system 10. If the computer system application 12 is encrypted, the wrapper program 14 may also decrypt the computer system application 12. The wrapper program 14 may then use a system call, such as exec( ) or fork( ), to launch the computer system application 12. Preferably, the wrapper program 14 would remove the computer system application 12 in the temporary location after the computer system application 12 has finished running.

In an alternative embodiment, the wrapper program 14 may display the challenge phrase 16 somewhere other than in the title bar. For instance, the wrapper program 14 may present a pop-up or other window which includes the challenge phrase 16. Alternatively, the wrapper program 14 may present an overlay on the screen, akin to a visible document watermark, which may be presented on top of all windows displayed to a user. Further, the challenge phrase 16 may be a Completely Automated Public Turing test to tell Computers and Humans Apart (also known as a CAPTCHA), which is a type of challenge-response test used to ensure that a response is not generated by a computer. On some operating systems, it may be preferable to present the challenge phrase 16 in a manner other than in the title bar as discussed above.

FIGS. 2a and 2b are illustrations of one embodiment of system 10 in accordance with the teachings of the present disclosure. FIG. 2a illustrates a computer system 10 with a computer system application 12 which is not protected. The computer system 10 can be implemented on one or more computing systems, which can include a personal computer, a workstation, a network computer, a hand held computer, or any other computing system capable of executing instructions stored in a memory. Further, the system 10 and wrapper program 14 can be written as a software program in any appropriate computer language. The system 10 includes a processing device, which can be any computer processing unit, and could be a single central processing unit, or a number of processing units configured to operate either in sequence or in parallel. The processing device can be configured to execute software processes which implement the steps disclosed herein. The system 10 will also include a memory capable of storing the steps necessary for a processing device to implement the steps disclosed herein. This memory could be in the form of memory resident within the processing device or in the form of standalone memory coupled to the processing unit via a communication path, such as a bus or a network.

FIG. 2b illustrates the same computer system application 12 as in FIG. 2a, but in this case it has been wrapped in the wrapper program 14 in accordance with the present disclosure. As such, the computer system application 12 may only be executed in accordance with the operation of the wrapper program 14, as discussed in detail above.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for protecting a computer system application, the method comprising the steps of:
installing a wrapper program;
embedding the computer system application in the wrapper program;
renaming the computer system application;
renaming the wrapper program to the name previously used by the computer system application;
generating a challenge phrase;
including the challenge phrase in the title bar of the wrapper program when the wrapper program is executed;
prompting the user for a password, wherein the password includes the challenge phrase;
comparing the password to the challenge phrase and launching the computer system application if the challenge phrase is successfully compared.

2. A method of protecting a computer system application, the method comprising the steps of:
wrapping the computer system application with a wrapper application;
altering the computer system application so that it can not be launched directly by a user; and
configuring the wrapper program to be launched when a user attempts to launch the computer system application whereby the wrapper program verifies the user's ability to launch the computer system application prior to launching the computer system application.

3. The method of claim 2 wherein the computer system application is a command-line interpreter.

4. The method of claim 3 wherein the command-line interpreter is cmd.exe.

5. The method of claim 2 wherein wrapping the computer system application comprises the steps of:
installing the wrapper program on a computer system; and
embedding the computer system application into the wrapper program.

6. The method of claim 5 wherein embedding the computer system application into the wrapper program comprises copying the computer system application into an alternate data stream.

7. The method of claim 5 wherein embedding the computer system application into the wrapper program comprises embedding the computer system application as a resource in the wrapper program.

8. The method of claim 2 wherein the wrapper program is installed on a New Technology File System.

9. The method of claim 2 wherein the wrapper program is installed on a File Allocation Table file system.

10. The method of claim 2 wherein altering the computer system application comprises renaming the computer system application.

11. The method of claim 2 wherein altering the computer system application comprises obfuscating the computer system application.

12. The method of claim 2 wherein altering the computer system application comprises obfuscating the name of the computer system application.

13. The method of claim 2 wherein altering the computer system application comprises encrypting the computer system application.

14. The method of claim 2 wherein the wrapper verifies the user's ability to launch the computer system application by performing steps comprising:
generating a challenge phrase; and
prompting the user to enter the challenge phrase in order to launch the computer system application.

15. The method of claim 14 wherein the challenge phrase is presented in a title bar of a window.

16. The method of claim 14 further comprising requiring the user to enter a system password concatenated with the challenge phrase wherein the wrapper program splits the user's input into a user password and a user challenge phrase entry and then performs the steps of:
authenticating the user using the user's password; and
determining if the user can launch the computer system application by comparing the user challenge phrase to the challenge phrase.

17. The method of claim 14 wherein the challenge phrase is a random number.

18. The method of claim 17 wherein the random number is a six decimal random number.

19. A system for protecting a computer system application, the system comprising:
a wrapper program, wherein the wrapper program is configured to embed the computer system application within the wrapper program such that the computer system application can not be launched directly by a user and wherein the wrapper program is configured to verify with a user an attempt to launch the computer system application prior to such launching; and
wherein the system is configured to launch the wrapper program when an attempt is made to launch the computer system application.

20. The system of claim 19 wherein the wrapper program verifies the user is attempting to launch the computer system application by generating a challenge phrase for the user to enter and comparing a user's input to the challenge phrase.
